(19) United States
(12) Patent Application Publication
(10) Pub. No.: US 2009/0192894 A1
(43) Pub. Date: Jul. 30, 2009

(54) Methods and apparatus for creating and managing green micro credits

(75) Inventor: Neal Dikeman, San Francisco, CA (US)

Correspondence Address: H. Michael Brucker, Suite 110, 5855 Doyle Street, Emeryville, CA, 94608, US

(73) Assignee: Carbon Flow, Inc.

(21) Appl. No.: 12/321,939

(22) Filed: Jan. 26, 2009

Related U.S. Application Data
(60) Provisional application No. 61/062,444, filed on Jan. 24, 2008.

(51) Int. Cl. G06Q 30/00; G06F 17/30

(52) U.S. Cl. 705/14; 707/104.1; 707/E17.044

(57) ABSTRACT

Methods and apparatus (systems) for effectively and efficiently creating green credit backed “micro” green credits utilizing the same regulatory agencies that certify green credits.

The present invention relates to the emergent world of certified green credits (see Glossary below) and, in particular, to methods and apparatus (systems) for effectively and efficiently including “micro” credits within that world.

### BACKGROUND

### Glossary

Because the field of environmental certified credits is an emergent one, terminology to describe the activities, participants and components involved has not yet reached a level of standardization; thus, for the purposes of this document and to establish a level of certainty in the terminology used herein, the following words and phrases shall have the following meanings throughout.
Baseline: The metric by which future performance is measured.
Benchmarking: The process of comparing the metric of one quantity or process to the metric of a standard (baseline) for that process or quantity or to a related process or quantity.
Creator: An individual or entity whose measured performance produces the justification for the award of green credits or green micro credits.
eRecord: An electronic record of activities typically maintained in a database.
Emission Allowances (Allowances): The Protocol-agreed ‘caps’ or quotas on the maximum amount of greenhouse gases for developed and developing countries listed in its Annex I [4]. In turn, these countries set quotas on the emissions of installations run by local business and other organizations, generically termed ‘operators’. Countries manage this through their own national ‘registries’ which are required to be validated and monitored for compliance by the UNFCCC[5]. Each operator has an allowance of credits where each unit gives the owner the right to emit one metric ton of carbon dioxide or other equivalent greenhouse gas. Operators that have not used up their quotas can sell their unused allowances as carbon credits, while businesses that are about to exceed their quotas can buy the extra allowances as credits, privately or on the open market. As demand for energy grows over time, the total emissions must still stay within the cap, but it allows industry some flexibility and predictability in its planning to accommodate this.

By allowing allowances to be bought and sold, an operator can seek out the most cost-effective way of reducing its emissions, either by investing in ‘cleaner’ machinery and practices or by purchasing emissions from another operator who already has excess ‘capacity’.

Since 2005, the Kyoto mechanism has been adopted for CO₂ trading by all the countries within the European Union under its European Trading Scheme (EU ETS), with the European Commission as its validating authority [6]. From 2008, EU participants must link with the other developed countries that ratified Annex I of the Protocol and trade the six most significant anthropogenic greenhouse gases. In the United States, which has not ratified Kyoto, and Australia, whose recent ratification comes into force in March 2008, similar schemes are being considered.
Green Credits: A special class of quasi-financial derivative products including production credits and offset (reduction) credits and emission allowances for emissions and energy processes as a mechanism mainly to improve environmental quality and energy efficiency through defining and then trading for cash or consideration in various aspects of environmental or energy commodities, production or use, including air emissions reduction credits like NOx, SOx, CO₂, and CO₂e (carbon dioxide, methane, nitrous oxide, sulfur hexafluoride, hydro fluorocarbons, and per fluorocarbons), as well as others, energy credits like Renewable Energy Credits (REC's) of various forms (i.e., wind, solar, geothermal, etc.) for producing electricity, and white tags (energy efficiency credits/energy use reduction credits). “Green credits” include the full range of environmental or energy credits (that now exist or may come into existence in the future) related to clean water, clean air, emissions reductions, reduction of pollutants, improved land or water use, or water rights, as well as other categories of energy and power.

Accordingly, the term “green credit” includes, without limitation, the terms “credit,” “carbon credit,” “certified credit,” and “emission allowance” or “allowance” and may be taken as interchangeable therewith in this document and includes specific credits (Kyoto Protocol CDM market), as well as their corresponding forms in relation to any credit, whether they are described here in specific or general terms.
Green Credits Certifying Body: Any entity that certifies green credits, including a regulatory agency of some type according to set rules, or an independent or industry certification agency having set rules or standards, or, in the case of a “voluntary” market, the company developing the credit, or any combination thereof.
Green Micro Credit: A small subdivision of a certified green credit. Sometimes also known as “micro credit”, “microcredit”, or “mini tag”. For example, carbon credits are denominated in units of 1 ton of CO₂ emitted or saved. This corresponds to about 1 MWh of electricity generated by burning coal. A micro carbon credit might be denominated in units of 1 Kg of CO₂ and would correspond to 1 KWh of electricity. At 2008 rates, an offset for a ton of CO₂ sells for about $10. Thus, using that metric, an offset for 1 Kg of CO₂ would have a value of about $0.01.
Green Credit Registry: A database and system to record the creation, lifecycle, and ownership of green credits. The registry assures the validity of green credits and underpins the market for trading them in a similar way to the share registry of a public company. Each certifying body maintains and administers a green credit registry for the green credits it has issued.
Green Project: A project designed to produce a result justifying the award of green credits (including emission allowances).
Independent Party (IP): An entity having no commercial relationship with a creator other than as a supplier of a commodity to that creator. Typically, an IP is an enterprise that supplies goods or services to a plurality (usually a very large number) of ongoing consumers and maintains a database of the transactions with and relevant performance of such customers. An example of an IP is an electricity utility that supplies power to consumers (who, by reducing their consumption, are creators) and maintains a database of their consumption over time.
Offset or Reduction Credits: A property right to the certified reduction of use or reduction of production of a particular commodity (like electricity use, or NOx pollutants, or carbon). In offset credits, the credit is often measured in terms of “commodity NOT produced as measured against a predefined baseline (defined either system-wide, project-wide or internally).
Production Credits: The production of a particular commodity (like electricity) using a specific methodology or resource (like renewable power in general, solar or wind resource in particular). The credit itself tends to refer to the “strip” or designated part of the commodity (or electrons) related to the methodology or resource and generally is “detachable” from the commodity itself. For example, a “REC” is essentially a certified contract that defines renewable property rights of a particular electricity commodity. In production credits, the credit often is measured in simple terms produced.
Project Documentation: A limited access database of elements of one or more (typically more) green projects and including the documentation, communications, data, and calculations used during the workflow of a project, including the creation, design, validation, certification, monitoring and settlement of green credits.
Project Methodology: The physical mechanisms by which green projects abate or reduce adverse environmental conditions (production or reduction).

### BACKGROUND OF THE INVENTION

There has been a significant increase in recent years in the creation, development and trading of a special class of quasi-financial derivatives products, referred to herein as “green credits,” related to the production and offset (reduction) of emissions and energy processes. Green credits have proven to be a viable mechanism to improve environmental quality and energy efficiency.

Green credits can be earned for: (1) the reduction of air emissions such as NOx, SOx, CO₂, CO₂e, and the like; (2) the creation of renewable energy sources (Renewable Energy Credits or RECs) of various forms (wind, solar, etc.) for producing electricity and other forms of energy; and (3) the reduction of the use of energy for a given activity (sometimes referred to as energy efficiency credits or energy use reduction credits or white tags). It is foreseeable that, in the future, green credits will include a wide range of environmental or energy activities related to clean water, air, emissions, pollutants, land or water use, or water rights or various categories of energy or power.

In general, “production credits” tend to involve the production of a particular commodity (like electricity) using a specific methodology or resource (like renewable power in general, solar or wind resource in particular). The green credit itself tends to refer to the “strip” or designated part of the commodity (or electrons) related to the methodology or resource and generally is “detachable” from the commodity itself. For example, a renewable energy credit (“REC”) is essentially a certified contract that defines renewable property rights of a particular electricity commodity. In production credits, the credit often is measured in simple terms of the commodity produced.

“Offset” or “reduction” credits tend to involve a property right to the certified reduction of use or reduction of production of a particular commodity (e.g., electricity, or NOx pollutants, or carbon). Offset credits are often measured in terms of “a commodity NOT produced” as measured against a predefined production baseline (which can be defined either system-wide, project-wide, or internally).

For a production project, the product (e.g., electricity) may be for a regulated and compliance driven market, in which case, the credit is generally defined by a regulatory agency of some type according to set rules. Where the product is for a “voluntary” market, the credit is generally defined either by the company developing the product or by an independent or industry certification agency. The same is true for a reduction project.

Credits can be earned for a “non-physical” portion or strip of the commodity being produced or reduced in that they cannot be physically separated for delivery from the commodity (e.g., in the case of RECs or white tags), whereas, in the case of reductions in emissions or pollution, the credits are given for a measured amount of a physical commodity such as CO₂ (a gas) or particulate matter or mercury (a solid) that can be physically captured or removed from the commodity stream, or a non-physical version of that commodity (use of less of the commodity, for example, would not physically separate or sequester the strip, but would reduce the strip). The credit earned is often based on a measured volume, weight, time, Kwh, or some other measurable output. Credits earned can also be measured in terms of time of production or reduction, e.g., 10,000 tons of CO₂ over five years.

Green credits have included air emissions reduction credits, like NOx, SOx, CO₂, and CO₂e, energy credits like Renewable Energy Credits (RECs) of various forms (wind, solar, etc.) for producing electricity, and white tags (energy efficiency credits/energy use reduction credits).

Green credits from the activities of a green project are created and are certified by a green credits certifying body. This body sets rules by which the production, reduction or offset are to be measured and proved by independent audit. The rules vary by the technology and processes of project and are called the project methodology. For example, a project to create electricity by burning sugar cane waste can claim to be reducing fossil fuel CO₂ emissions. According to the Kyoto Protocol, this claim can be converted into CDM CO₂ offset credits (CERs) which have a monetary value. The project would register with the UNFCCC Executive Board and use methodology “AM0007: Analysis of the least-cost fuel option for seasonally-operating biomass cogeneration plants” to determine its CO₂ reduction. An independent auditor would verify that the reduction had in fact occurred and submit its findings and supporting data to the UNFCCC Executive Board. If satisfied, the UNFCCC Executive Board would issue the CERs.

Green credit certification processes work for industrial scale projects, but are too complicated and costly to be applied on a smaller scale for small enterprises such as families, building owners, and small businesses. The present invention provides a novel system, allowing the automatic aggregation of the small contributions of many creators (micro credits) into tradable certified green credits under the auspices of a larger auditable green project.

Green micro credits already exist in a form typically found in the voluntary market. As an example, numerous websites and retailers embed micro credits in their products (e.g. a green mini tag sold at a ski resort to offset the customer's carbon emissions from skiing). Unlike the present invention, these green micro credits are created by subdividing an existing green credit. Once subdivided, these green credits cease to be tradable and cannot be recombined back into green credits. Thus, no registry of such credits exists nor are they available for future trading

One of the features of the present invention that allows very small projects (including on an individual level) to participate in a full scale green credit program is found in the independence between the credit creator and the third party (TP) that provides verifiable data about the creator's performance. Other than the supplier-customer relationship, there is no commercial relationship between the creator and the source of the data verifying the creator's performance. For example, a utility company in the normal course of its business provides electricity to thousands of homes and small enterprises (customers) and, in the process, creates and maintains a database of information for each customer including its usage of electricity over time. It also mandates electronic entry and processing of the data. By contrast, in a full scale CDM project, the data necessary to report and verify the project's performance is provided by the project operators (creators) themselves, and the submission of data is typically manual. This imposes a much greater auditing overhead and, thus, for practical reasons, CDM programs have heretofore been restricted to projects of a scale large enough to justify the qualification and ongoing monitoring costs typically associated therewith.

At present, the protocols of established bodies recognized to issue certified green credits for major projects are not amenable to recognize and issue certified micro credits. Their requirements and procedures are too complex and expensive to accommodate micro projects that are not of a scale equivalent to hundreds of tons of carbon.

There is, however, a great potential for reducing the negative impact on the environment from activities (projects) on an individual scale. Since certifying bodies are already established and functioning, it is advantageous to provide a system that can utilize the functions of those bodies to accommodate micro credits without major changes to their protocols. By doing so, individuals and small enterprises (micro projects) can be afforded the means and incentive rewards for participating in the “greening” of the planet. The present invention provides such a system.

### BRIEF DESCRIPTION OF THE INVENTION

In one embodiment, the present invention provides a system by which a plurality of creators can individually earn green credit backed micro credits for their performance in connection with an independent provider, where the system comprises: a provider database maintained by the provider independently of the creators which includes information specific to each creator and performance data of each creator; a project database that interfaces with said provider database and creates an eRecord for each creator wherein said eRecord includes creator information and performance data from said provider database; a computer-enabled baseline generator that establishes a performance baseline for each creator using data in that creator's said eRecord; a computer-enabled green micro credit calculator that interfaces with said project database and, using the baseline established for each creator from the baseline generator, calculates the micro credits earned by each creator using data in that creator's eRecord; and a project developer independent of the creators having access to said project database, said baseline generator and said micro credit calculator and that interfaces with a green credit certifying body to obtain certified green credits based on the presentation of the performance of the creators as a single program.

In one embodiment, the method of the invention allows a plurality of creators to individually earn micro green credits for their performance in connection with an independent provider who maintains, independently of the creators, a provider database that includes information specific to each creator and performance data of each creator which comprises: creating an eRecord for each creator wherein said eRecord includes creator information and performance data from said provider database; establishing a performance baseline for each creator using data in that creator's eRecord; calculating the green micro credits earned by each creator using the established performance baseline and data in that creator's eRecord; recording the micro credits earned by each creator in the eRecord of that creator; and qualifying the creators' performances as a program for certified green credits wherein the number of micro credits recorded in the eRecords corresponds to the number of certified green credits earned by the creators' performances.

The foregoing and other features and advantages of the invention will be more readily understood upon consideration of the following detailed description of the invention taken in conjunction with the accompanying drawing.

### BRIEF DESCRIPTION OF THE DRAWING

FIG. 1 is a flow diagram of the system of the invention.

### DETAILED DESCRIPTION OF THE PREFERRED EMBODIMENT

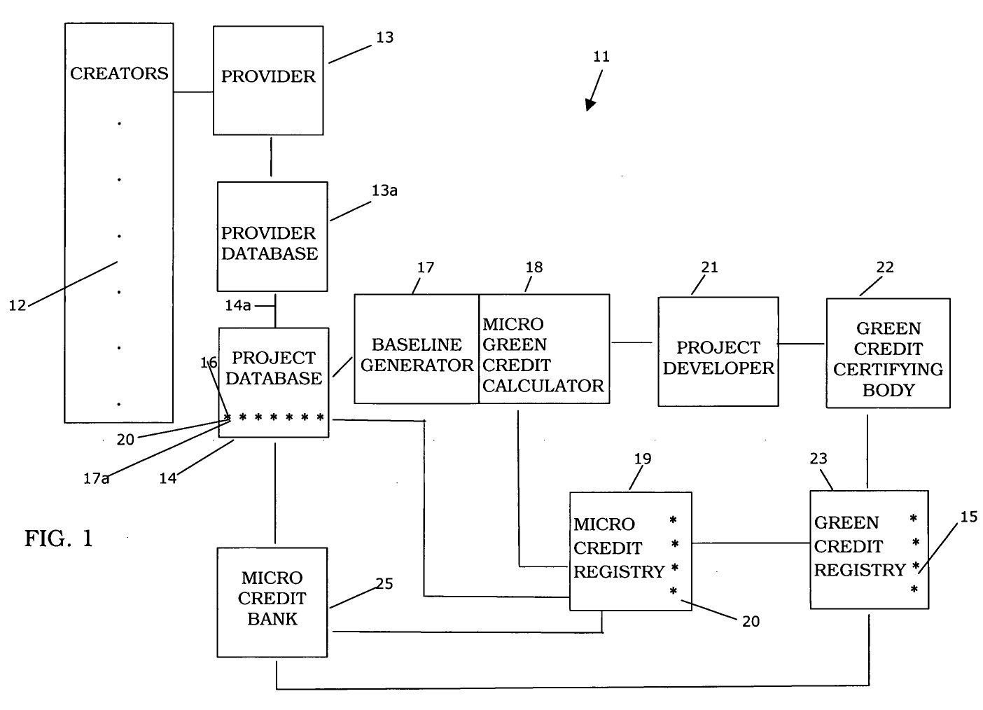

Referring to FIG. 1, the system 11 of the present invention is illustrated by a flow diagram where some of the functions represented are performed by one or more computers in a manner well known in the art.

A group of creators 12 all make contributions to benefiting the environment, but at such a micro level that they cannot individually participate in the rewards for doing so afforded by established green credit issuing bodies which operate at a level that is only geared to large scale projects. While there are white tag programs, they are largely voluntary and do not interface with certified green credit programs and, thus, are not able to take advantage of the rewards that green credit programs afford. The system 11 of the present invention provides, for the first time, a practical system for bringing micro level creators 12 into the macro system of certified green credits. For purposes of describing the invention, creators 12 will be assumed to be consumers of a commodity that has a known and calculable impact on the environment, such as electricity. The invention, however, is not limited by the particular measurable activity of the creators 12 that is offered as the justification for the award of certified green credit rewards.

The system 11 includes a plurality of creators 12 who receive a commodity (such as electricity or natural gas or water, etc.) from a provider 13 that maintains a provider database 13a in the normal course of business. In the case of an electric utility, the database would contain information about the creator, plus a historical record of the electricity usage by creator 12. Selected information from provider database 13a (particularly, but not exclusively, usage) is made available via a data exchange interface 14a to a project database 14 that includes, among others, a creator eRecord 16 for each creator 12. An eRecord 16 includes the identity of the creators and that creator's usage over time of the commodity being supplied by provider 13. It will be understood by those skilled in the art that creators 12 can be households, apartment buildings, small businesses and the like and that databases 13a and 14 are computer-managed and can be in separate or the same data storage device.

Other than the supplier-customer relationship between creators 12 and provider 13, there is no other commercial relationship between them. The creators 12 have no control of the data in database 13a or the usage data in their eRecords 16. By that measure, the provider 13 is independent of the creators 12 and the data used as the measure of green credits cannot be influenced by creators 12 other than by their performance with regard to the commodity being provided by the provider 13.

For each creator 12, a usage baseline 1 7a is calculated by a computer-enabled baseline calculator 17 using one of many possible algorithms, taking into account information available from that creator's eRecord 16. The baseline can be based on historical performance of the creator 12 and/or on other factors such as the size of a structure, the number of inhabitants, the average of like situated creators, etc. The invention does not depend on any particular formula used to establish a baseline so long as it is acceptable to a certifying body. The baseline 17 is added to the information in that creator's eRecord 16. A micro green credit calculator 18 is a computer-enabled algorithm that converts the consumption reduction performance of each creator 12, relative to its baseline, into micro credits 20 which are maintained in a micro credit registry (database) 19 as well as in the creator's eRecord 16.

A project developer 21 interacts with a green credit certifying body 22 for certification and approval of a program based on the individual contributions of creators 12 (that may number in the thousands or tens of thousands). By representing all of the creators 12 as a single program, the expense and time required to certify and monitor the program as a certified green credit program is justified but, at the same time, the system treats each creator as a separate entity whose individual contribution is recognized and rewarded according to that creator's individual performance. The certifying body 22 can include a company developing the credit or an independent industry-certifying agency, as in a voluntary project.

Being a reduction project, it is performance based, and to qualify for certified green credits, the body need only authenticate the methodology of the system, the accuracy of the eRecords 16 and the acceptability of the calculations used by baseline calculator 17 and the micro green credit calculator 18. Once approved and operational, the system will produce certified green credits 15 which can be maintained in a certified green credit registry 23 until they are sold, transferred or extinguished. The micro credits 20 attributable to the contribution of each creator 12 can be added to each eRecord 16 whereby an examination of an eRecord 16 can reveal the micro credits 15 earned by that creator 12. The micro credits 20 correspond to the credits 15 and can add up to the number of credits 15 at any given time.

The system 11 of the invention has inherent reliability because the database 14 from which all usage data emanates is created and maintained independently of the creators 12 and, typically, for some other business purpose (i.e., to bill the creator for consumption). Furthermore, the baseline generator 17 and the micro green credit calculator 18 are designed, operated and verified independently of the creators 12. Because of the unique relationship between the components of the system 11, the invention has inherent reliability which simplifies the process for project acceptance and certification by a green credit registry 15 as well as the monitoring and verification of performance, which also reduces the cost of establishing, certifying and operating the project.

The invention, for the first time, allows micro contributors to participate in certified green credit programs without having to directly qualify their individual efforts with a certifying body 22.

A micro credit bank 25 can be established using the micro credit data from project database 14 (or, alternatively, directly from micro credit registry 19) and the green credit registry 15 where the bank 25 can act as a sub-registry for micro credits, enable trading and sales of micro credits, interface with official registries on a macro level and tracking of sales and retirement of micro credits; in essence, making a market for micro credits.

Of course, various changes, modifications and alterations in the teachings of the present invention may be contemplated by those skilled in the art without departing from the intended spirit and scope thereof.

As such, it is intended that the present invention only be limited by the terms of the appended claims.

What is claimed is:

1. A system by which a plurality of creators can individually earn micro green credits for their performance in connection with an independent provider, comprising:
a provider database maintained by the provider independently of the creators which includes information specific to each creator and performance data of each creator;
an eRecord for each creator that is informed by said provider database and includes information specific to that creator and performance data of that creator;
a computer-enabled baseline generator that establishes a performance baseline for each creator using data in that creator's said eRecord; and
a computer-enabled green micro credit calculator that interfaces with said project database and said baseline generator and calculates micro credits earned by each creator using data in that creator's eRecord.

2. A system by which a plurality of creators can individually earn green credit backed micro credits for their performance in connection with an independent provider, comprising:
a provider database maintained by the provider independently of the creators which includes information specific to each creator and performance data of each creator;
a project database that interfaces with said provider database and creates an eRecord for each creator wherein said eRecord includes creator information and performance data from said provider database;
a computer-enabled baseline generator that establishes a performance baseline for each creator using data in that creator's said eRecord;
a computer-enabled green micro credit calculator that interfaces with said project database and, using the baseline established for each creator from the baseline generator, calculates the micro credits earned by each creator using data in that creator's eRecord;
a project developer independent of the creators having access to said project database, said baseline generator and said micro credit calculator and that interfaces with a green credit certifying body to obtain certified green credits based on the presentation of the performance of the creators as a single program.

3. The system of claim 2 further comprising:
a green credit registry for the green credits obtained from the green credit certifying body;
a micro credit registry in which all micro credits from said green micro credit calculator are registered for each creator wherein the number of registered green micro credits corresponds to the number of registered certified green credits.

4. The system of claim 2 wherein the provider is a supplier of electricity and the creators are electricity customers of provider.

5. The system of claim 2 wherein the provider is a supplier of natural gas and the creators are natural gas customers of provider.

6. The system of claim 2 wherein the provider is a supplier of water and the creators are water customers of provider.

7. The system of claim 2 further comprising:
a micro credit bank in which micro credits are marketed.

8. A method by which a plurality of creators can individually earn micro green credits for their performance in connection with an independent provider who maintains, independently of the creators, a provider database that includes information specific to each creator and performance data of each creator comprising:
creating an eRecord for each creator that is informed by said provider database and includes information specific to that creator and performance data of that creator;
establishing a performance baseline for each creator using data in that creator's said eRecord; and
calculating the green micro credits earned by each creator using data in that creator's eRecord.

9. A method by which a plurality of creators can individually earn micro green credits for their performance in connection with an independent provider who maintains, independently of the creators, a provider database that includes information specific to each creator and performance data of each creator comprising:
creating an eRecord for each creator wherein said eRecord includes creator information and performance data from said provider database;
establishing a performance baseline for each creator using data in that creator's eRecord;
calculating the green micro credits earned by each creator using the established performance baseline and data in that creator's eRecord;
recording the micro credits earned by each creator in the eRecord of that creator; and
qualifying the creators' performances as a program for certified green credits wherein the number of micro credits recorded in the eRecords corresponds to the number of certified green credits earned by the creators' performances.

10. The method of claim 9 wherein the provider is a provider of electricity and the creators are electricity customers of provider.

11. The method of claim 9 wherein the provider is a provider of natural gas and the creators are natural gas customers of provider.

12. The method of claim 9 wherein the provider is a provider of water and the creators are water customers of provider.

13. The method of claim 9 further comprising:
establishing a micro credit bank to create a market for micro credits.

14. The method of claim 13 wherein the bank facilitates the exchange of micro credits for certified green credits.
